(19) United States
(12) Patent Application Publication
(10) Pub. No.: US 2024/0406100 A1
(43) Pub. Date: Dec. 5, 2024

(54) OPERATING METHOD FOR ELECTRONIC APPARATUS FOR TRANSMITTING SIGNAL AND ELECTRONIC APPARATUS SUPPORTING THEREOF

(71) Applicant: AGENCY FOR DEFENSE DEVELOPMENT, Daejeon (KR)

(72) Inventors: Byung Gak JO, Daejeon (KR); Yong Up JANG, Daejeon (KR); Jae Hyun HAM, Daejeon (KR); Jae Seang LEE, Daejeon (KR)

(21) Appl. No.: 18/616,461

(22) Filed: Mar. 26, 2024

(30) Foreign Application Priority Data
Jun. 2, 2023 (KR) 10-2023-0071582

(51) Int. Cl. H04L 45/00; H04B 7/185; H04L 45/745

(52) U.S. Cl. CPC H04L 45/54; H04B 7/18584; H04L 45/745

(57) ABSTRACT

According to the present disclosure, systems, devices, methods, and instructions for transmitting a signal may include acquiring routing table information including information associated with a plurality of Internet Protocol (IP) addresses, generating, based on the routing table information, identification information for a predetermined IP address associated with another electronic apparatus to which a data packet is to be transmitted, and transmitting a signal including the identification information and the data packet.

### PRIORITY APPLICATION

This application claims the benefit of Korean Patent Application No. 10-2023-0071582, filed on Jun. 2, 2023, in the Korean Intellectual Property Office, the disclosure of which is incorporated herein by reference in its entirety.

### FIELD OF THE INVENTION

The present disclosure relates to systems, devices, methods, and instructions for transmitting a signal, and more particularly, to transmitting a signal including identification information on a satellite and a cell.

### BACKGROUND OF THE INVENTION

Existing routers operated on a ground mainly perform a layer 3 packet forwarding function, and various processes such as processing of routing table lookup, a time to live (TTL), and a checksum are performed after a router reads an Internet Protocol (IP) header to transmit an IP packet to a next hop. In a process of the routing table lookup, a relatively long processing time is required because a longest prefix matching method is used. Since such software-based packet processing uses high-speed processing ability, a high-performance central processing unit (CPU) is required for implementing hardware.

With performance of a component for ground use having been advanced, the component for ground use may support a high packet processing speed for layer 3-based IP packet processing. However, for a component for use in a space environment, performance may be limited due to using a previous generation component qualified for the space environment. Accordingly, there may be a burden in implementing the layer 3-based IP packet processing. For example, an Internet Routing In Space (IRIS) system developed by Cisco, an American corporation, and provided to a satellite may have a router of a L3 method and have a burden in implementing IP packet processing due to limited packet processing performance of 250 megabits per second (Mbps).

### SUMMARY OF THE INVENTION

An aspect provides a method of an electronic apparatus transmitting a signal including identification information on a satellite and a cell.

Technical goals of the present disclosure are not limited to the aforementioned technical features, and other unstated technical goals may be inferred from example embodiments below.

According to various example embodiments, there is provided an operation method of electronic apparatus for transmitting a signal and an electronic apparatus supporting thereof.

According to various example embodiments, there is provided a method of an electronic apparatus transmitting a signal, the method including acquiring routing table information including information associated with a plurality of Internet Protocol (IP) addresses, generating, based on the routing table information, identification information for a predetermined IP address associated with another electronic apparatus to which a data packet is to be transmitted, and transmitting a signal including the identification information and the data packet.

The routing table information may include, as information in a form of a table, each IP address included in the plurality of IP addresses, and a satellite identifier (ID) and a cell ID corresponding to each respective IP address of the plurality of IP addresses.

The routing table information may be set to correspond to a satellite group including a first satellite for a first cell corresponding to the electronic apparatus, and the routing table information may be shared with a plurality of satellites included in the satellite group.

The generating of the identification information may include identifying information on the predetermined IP address, identifying a cell ID of a second cell corresponding to the another electronic apparatus and the predetermined IP address and a satellite ID of a second satellite for the second cell based on the routing table information and the information on the predetermined IP address, and generating the identification information which includes the cell ID and the satellite ID.

The identification information may be set based on a plurality of bits, and the plurality of bits may include one or more bits for the satellite ID, one or more bits for the cell ID, one or more bits for indicating communication quality, and one or more reserve bits.

A number of the plurality of bits may be determined based on an altitude at which a satellite group including the second satellite and a first satellite for a first cell to which the electronic apparatus corresponds is operated.

The transmitting of the signal may include identifying a first satellite for a first cell to which the electronic apparatus corresponds, and transmitting the signal to the first satellite.

Based on a satellite ID included in the identification information, the signal may be transmitted from the first satellite to a second satellite corresponding to the satellite ID, and based on a cell ID included in the identification information, the signal may be transmitted from the second satellite to a second cell corresponding to the cell ID.

According to various example embodiments, there is provided a non-transitory computer-readable storage medium comprising a computer program for executing a signal transmission method, and the signal transmission method includes acquiring routing table information including information associated with a plurality of IP addresses, generating, based on the routing table information, identification information for a predetermined IP address associated with another electronic apparatus to which a data packet is to be transmitted, and transmitting a signal including the identification information and the data packet.

According to various example embodiments, there is provided an electronic apparatus for transmitting a signal, the electronic apparatus including a processor, and one or more memories in which one or more instructions are stored, and when executed, the one or more instructions control the processor to perform acquiring routing table information including information associated with a plurality of IP addresses, generating, based on the routing table information, identification information for a predetermined IP address associated with another electronic apparatus to which a data packet is to be transmitted, and transmitting a signal including the identification information and the data packet.

The example embodiments of the present disclosure described above are merely some of example embodiments of the present disclosure. It will be understood by those skilled in the art that various example embodiments in which technical features of the various example embodiments of the present disclosure are reflected may be derived based on the following detailed description.

According to the present disclosure, it is possible to provide a method of an electronic apparatus transmitting a signal including identification information on a satellite and a cell. Thus, it is possible to effectively perform satellite communication.

Effects of the present disclosure are not limited to the above-mentioned effects, and effects other than the above-mentioned effects can be clearly understood by those of ordinary skill in the art from the following descriptions.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram illustrating a signal transmission system in which an operation method of an electronic apparatus for signal transmission is to be implemented according to various example embodiments;

FIG. 2 is a diagram illustrating a configuration of a communication node according to various example embodiment;

FIGS. 3 and 4 are diagrams illustrating a structure and insertion of a label for multi-protocol label switching (MPLS) in related arts;

FIG. 5 is a diagram illustrating a structure of a MPLS-based network;

FIG. 6 is a block diagram illustrating an electronic apparatus for performing a signal transmission method according to the present disclosure;

FIG. 7 is a diagram illustrating an operation method of an electronic apparatus for signal transmission according to various example embodiments;

FIG. 8 is a diagram illustrating an example of a cell arrangement operation structure of a low-orbit communication satellite group;

FIG. 9 is a diagram illustrating a label structure for a low-orbit satellite group according to the present disclosure;

FIG. 10 is a diagram illustrating an example of a network structure based on a label structure for a low-orbit satellite group according to the present disclosure.

### DETAILED DESCRIPTION

The following example embodiments are combinations of elements and features in various example embodiments in a predetermined form. Each element or feature may be considered selective unless there is an additional descriptive statement. Each element or feature may be embodied in a form without being combined with another element or feature. Also, various example embodiments may include a combination of some elements and features. An order of operations described in various example embodiments may be changed. Some elements or features in any example embodiment may be included in another example embodiment or may be replaced with an element or feature corresponding to another example embodiment.

In descriptions with reference to the drawings, a procedure or an operation obscuring a gist of various example embodiments is not described. A procedure or operation understandable at a level of those skilled in the art is also not described.

In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software. In addition, expression “a” or “an”, “one”, “the”, and the like may include all of the singular and the plural in a context describing various example embodiments (especially, in a context of the following claims) unless otherwise indicated in the present disclosure or clearly rebutted by the context.

Hereinafter, aspects according to various example embodiments will be described with reference to the drawings. Detailed descriptions with reference to the drawings are to describe exemplary aspects, not only one aspect.

In addition, specific terms used in various example embodiments are provided to help to understand various example embodiments. The usage of the specific terms may be changed to other modifications in the scope of the technical idea of various example embodiments.

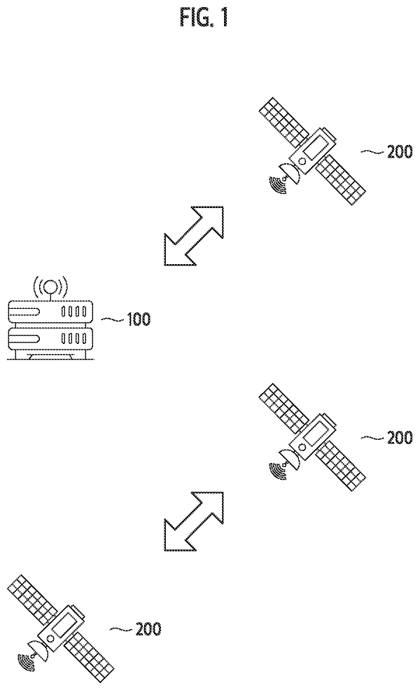

FIG. 1 is a diagram illustrating a signal transmission system in which an operation method of an electronic apparatus for signal transmission is to be implemented according to various example embodiments.

Referring to FIG. 1, the signal transmission system according to various example embodiments may be implemented by various types of electronic apparatuses. For example, the signal transmission system may be implemented between a communication node represented by a ground terminal 100 including a router and a communication node represented by a satellite 200 or between communication nodes represented by the satellite 200. At this point, the communication node represented by the ground terminal 100 and the communication node represented by the satellite 200 may be one or a portion of communication nodes in any form for providing or using a satellite communication service. In other words, the signal transmission system may be implemented by various communication nodes, and a communication node described as an entity of the signal transmission system in the present disclosure may be a concept including a communication node in any form for providing or using the satellite communication service. Particularly in the present disclosure, the signal transmission system may be implemented by focusing on performing the signal transmission system through the communication node represented by the ground terminal 100.

In the signal transmission system of the present disclosure according to FIG. 1, the communication node represented by the ground terminal 100 including the router or the communication node represented by the satellite 200 may perform an operation according to various example embodiments of the present disclosure. Meanwhile, the signal transmission system according to various example embodiments may not be limited as illustrated in FIG. 1 and may be implemented in other various electronic apparatuses or servers.

The signal transmission system according to various example embodiments may include various modules for the operation. The modules included in the signal transmission system may be computer code or one or more instructions implemented so that a physical apparatus (e.g., a communication node including the ground terminal 100 or the satellite 200) in which the signal transmission system is implemented (or included) may perform a designated operation. That is, the physical apparatus in which the signal transmission system is implemented may store a plurality of modules in a form of the computer code in a memory, and when the plurality of modules stored in the memory is executed, the plurality of modules may allow the physical apparatus to perform designated operations corresponding to the plurality of modules.

Alternatively, the signal transmission system according to various example embodiments may be implemented by a non-transitory computer-readable storage medium (or a non-transitory recording medium) for the operation. An operation method for signal transmission may be implemented with a software module or an algorithm and stored, in a computer-readable recording medium, as pieces of computer-readable code or program instructions executable in a processor. At this point, the computer-readable recording medium includes a magnetic storage medium (e.g., a read-only memory (ROM), a random-access memory (RAM), a floppy disk, a hard disk, or the like), an optical reading medium (e.g., a compact disc (CD)-ROM or a digital versatile disc (DVD)), or the like. The computer-readable recording medium may be distributed among computer systems connected to each other through a network, and the computer-readable code may be stored and executed in a distributed manner. A medium may be read by a computer, stored in a memory, and executed by a processor.

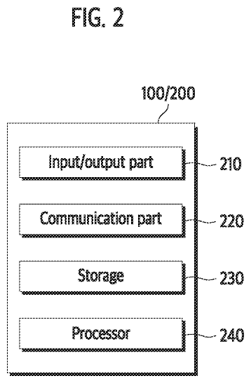

FIG. 2 is a diagram illustrating a configuration of a communication node according to various example embodiments.

Referring to FIG. 2, a communication node represented by the ground terminal 100 including a router or represented by the satellite 200 may include an input/output part 210, a communication part 220, a storage 230, and a processor 240.

The input/output part 210 may be various interfaces, connection ports, or the like receiving a user input or outputting information to a user. The input/output part 210 may include an input module and an output module. The input module receives the user input from the user. The user input may include various forms such as a key input, a touch input, or a voice input. The input module which is to receive the user input as such may include a traditional form of a keypad, a keyboard, a mouse, as well as a touch sensor sensing a touch of the user, a microphone receiving a voice signal, a camera recognizing a gesture through image recognition, a proximity sensor including at least one of an illumination sensor or an infrared sensor sensing approach of the user, a motion sensor recognizing movement of the user through an acceleration sensor, a gyro sensor, or the like, or other various forms of input devices sensing or receiving the various forms of the user input. The input module according to example embodiments of the present disclosure may include at least one of the above-described devices. At this point, the touch sensor may be implemented with a piezoelectric or capacitive touch sensor sensing a touch through a touch panel or a touch film attached to a display panel, an optical touch sensor sensing a touch with an optical method, or the like. In addition, the input module may be implemented in a form of an input interface (e.g., a universal serial bus (USB) port, a personal system 2(PS/2) port, or the like) connecting an external input device that receives the user input instead of autonomously sensing the user input. Also, the output module may output a variety of information. The output module may include at least one of a display outputting an image, a speaker outputting a sound, a haptic device generating a vibration, and other various forms of output devices. Further, the output module may be implemented in a form of an output interface of a port type connecting the above-described individual output devices.

For example, an output module in a form of the display may display a text, a still image, and a moving image. The display may include at least one of a liquid crystal display (LCD), a light emitting diode (LED) display, an organic light emitting diode (OLED) display, a flat panel display (FPD), a transparent display, a curved display, a flexible display, a three-dimensional (3D) display, a holographic display, a projector, and other various forms of devices for performing an image output function. The display as such may be in a form of a touch display integrally configured with the touch sensor of the input module.

The communication part 220 may communicate with another apparatus. Accordingly, the communication node represented by the ground terminal 100 or represented by the satellite 200 may transmit and receive information to and from the other apparatus through the communication part. For example, the communication node represented by the ground terminal 100 or represented by the satellite 200 may perform mutual communication or communication with the other apparatus by using the communication part.

At this point, communication, namely, transmission and reception of data may be performed in wire or wirelessly. To this end, the communication part may be implemented with a wired communication module for connecting to the Internet or the like through a local area network (LAN), a mobile communication module for connecting to a mobile communication network via a mobile communication server to transmit and receive the data, a near field communication module using a communication method including a type of a wireless local area network (WLAN) such as wireless fidelity (Wi-Fi) or a communication method including a type of a wireless personal area network (WPAN) such as Bluetooth or ZigBee, a satellite communication module using a global navigation satellite system (GNSS) such as a global positioning system (GPS), or a combination thereof.

The storage 230 may store a variety of information. The storage 230 may temporarily or permanently store data. For example, an operating system (OS), data for hosting a website, data on a program or an application (e.g., a web application) for generating braille, or the like may be stored in the storage 230 of the communication node represented by the ground terminal 100 or represented by the satellite 200. Further, the storage 230 may store modules in a form of computer code as described above.

An example of the storage 230 may include a hard disk drive (HDD), a solid state drive (SSD), a flash memory, a ROM, a RAM, or the like. The storage 230 as such may be provided in a built-in type or a detachable type.

The processor 240 may control overall operations of the communication node represented by the ground terminal 100 or represented by the satellite 200. To this end, the processor 240 may perform calculation and processing of a variety of information and may control operations of components of the communication node represented by the ground terminal 100 or represented by the satellite 200. For example, the processor 240 may execute a program or an application for signal transmission. The processor 240 may be implemented with a computer or a device similar thereto depending on hardware, software, or a combination thereof. In terms of the hardware, the processor 240 may be implemented in a form of an electronic circuit processing an electric signal to perform a control function. In terms of the software, the processor 240 may be implemented in a form of a program driving the processor 240 as the hardware. Meanwhile, unless described otherwise, it may be construed that an operation of the communication node represented by the ground terminal 100 or represented by the satellite 200 may be performed by control of the processor 240. In other words, when the above-described modules implemented in the signal transmission system are executed, it may be construed that the modules allow the processor 240 to control the communication node represented by the ground terminal 100 or represented by the satellite 200 to perform the following operations.

In summary, various example embodiments may be implemented in various ways. For example, various example embodiments may be implemented with hardware, firmware, software, or a combination thereof.

When various example embodiments are implemented with the hardware, a method according to various example embodiments may be implemented by one or more of application specific integrated circuits (ASICs), digital signal processors (DSPs), digital signal processing devices (DSPDs), programmable logic devices (PLDs), field programmable gate arrays (FPGAs), a processor, a controller, a micro controller, a micro-processor, or the like.

When various example embodiments are implemented with the firmware or the software, the method according to various example embodiments may be implemented in a form of a module, a procedure, a function, or the like performing functions or operations described below. For example, software code may be stored in a memory and driven by a processor. The memory may be inside or outside the processor, and may send and receive data to and from the processor by various methods already known in advance.

Hereinafter, various example embodiments will be described in more detail based on the technical idea described above. The above-described details may be applied to various example embodiments to be described below. For example, an operation, a function, a term or the like not defined in various example embodiments to be described below may be performed and described based on the above-described content.

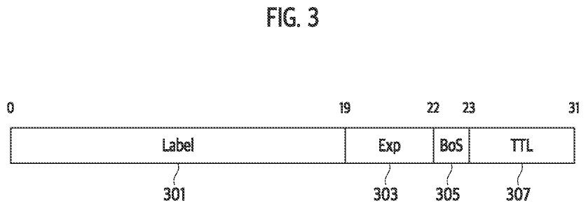

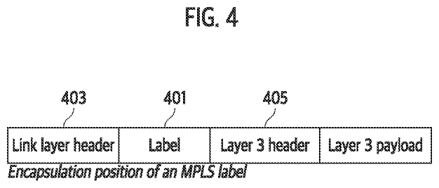

FIGS. 3 and 4 are diagrams illustrating a structure and insertion of a label for multi-protocol label switching (MPLS) in related arts.

An MPLS technique is proposed for implementing high-speed label switching by using hardware with limited performance. The MPLS technique may substitute for routing table lookup of which processing takes a long time due to being based on a label switching method of processing a packet based on a label having a short and fixed length. Through this, the MPLS technique may allow high-speed data transmission by simplified hardware. A label structure of MPLS illustrated in FIG. 3 may include the following fields and field values:
Label 301 (having 20 bits) that is a field having twenty bits and used for indicating a unique label value,
Exp 303 (having 3 bits) that is used for indicating a class of a service,
BoS 305 (having 1 bit) that is used for indicating a bottom of a label stack when multiple labels are used, and
TTL 307 (having 8 bits) that performs a function identical to a time to live (TTL) of an Internet Protocol (IP) packet and has a value to be decreased one by one for preventing a packet loop when reaching a next hop.

At this point, a label 401 may be used with being inserted between a link layer 403 that is layer 2 and a layer 3 header 405. Also, the label 401 may support various network layer protocols such as IPv4 or IPv6 and have a character of not depending on a predetermined link layer protocol.

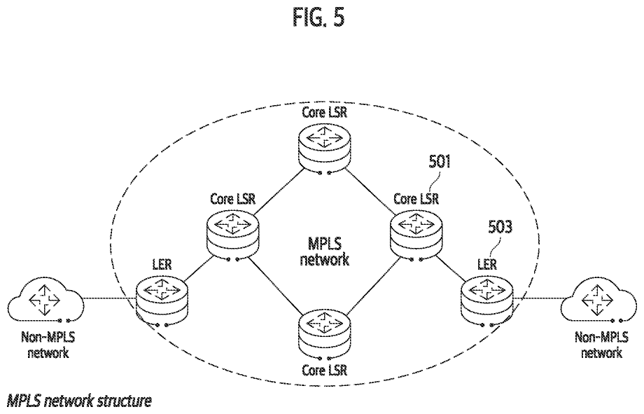

FIG. 5 is a diagram illustrating a structure of a MPLS-based network.

In FIG. 5, a label switching router (LSR) may perform high-speed packet switching only with label information when a label is inserted in a packet in a label edge router (LER). Each component included in the structure of the network in FIG. 5 may be defined as follows:
LSR 501 that corresponds to a network apparatus supporting MPLS label switching and is a basis of an MPLS network, and
LER 503 that serves as an interface for a non-MPLS network and an MPLS domain and in which the label is inserted in the packet.

For an MPLS technique for a satellite in a space environment, an MPLS technique-based satellite-borne packet switch is currently under development to support a gigabits per second (Gbps) speed in a public composite communication satellite (e.g., Chollian 3).

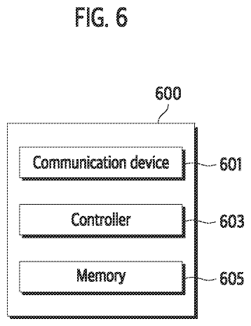

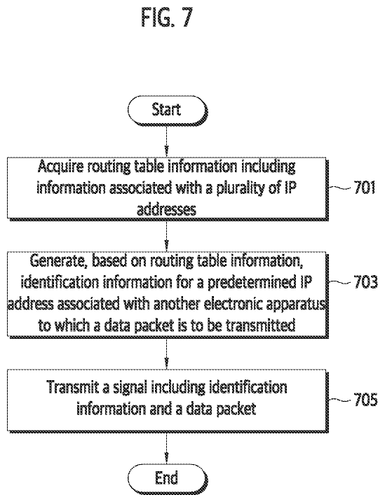

In an existing MPLS technique devised for providing high-speed packet switching performance to hardware having limited performance, a unique identifier including twenty bits as described above may be used as the label. In contrast, a method of improving a label structure used in the MPLS to include identification information in different forms suitable for a low-orbit satellite group characteristic, and transmitting a signal with forming an efficient network and processing a packet through the improved label structure is proposed in the present disclosure for reducing a burden in processing in a satellite payload of the low-orbit satellite group. In the following description of the present disclosure, an electronic apparatus configured as illustrated in FIG. 6 may perform a signal transmission method as illustrated in FIG. 7.

FIG. 6 is a block diagram illustrating an electronic apparatus for performing a signal transmission method according to the present disclosure.

In FIG. 6, an electronic apparatus 600 may include a communication device 601, a controller 603, and a memory 605. Each component included in the electronic apparatus 600 according to FIG. 6 may correspond to a configuration of the communication node according to FIG. 2, or the electronic apparatus 600 may include the configuration of the communication node according to FIG. 2. For example, the communication device 601 included in the electronic apparatus 600 may correspond to the communication part 220 of FIG. 2 to transmit and receive a signal to and from an external apparatus.

The electronic apparatus 600 according to FIG. 6 may be connected to another electronic apparatus through the communication device 601. Based thereon, the electronic apparatus 600 may transmit and receive a signal to and from the other electronic apparatus.

The controller 603 may control the electronic apparatus 600 to perform the signal transmission method which includes various example embodiments according to FIGS. 7 through 10 to be described below. For example, the controller 603 may control the electronic apparatus 600 to perform operation 701 through operation 705 of FIG. 7 and control the electronic apparatus 600 to transmit and receive a variety of information used for performing operation 701 through operation 705 of FIG. 7.

The memory 605 may be a volatile memory or a non-volatile memory. Program code used for the controller 603 to execute a program for performing the signal transmission method may be stored in a memory 605.

The electronic apparatus 600 for performing the signal transmission method in the present disclosure is not limited to a configuration of FIG. 6, and other components in general use may be included in the electronic apparatus 600 of the present disclosure in addition to various components illustrated in FIG. 6.

FIG. 7 is a diagram illustrating an operation method of an electronic apparatus for signal transmission according to various example embodiments.

In FIG. 7, the electronic apparatus may acquire routing table information including information associated with a plurality of IP addresses in operation 701, generate, based on the routing table information, identification information for a predetermined IP address associated with another electronic apparatus to which a data packet is to be transmitted in operation 703, and transmit a signal including the identification information and the data packet in operation 705.

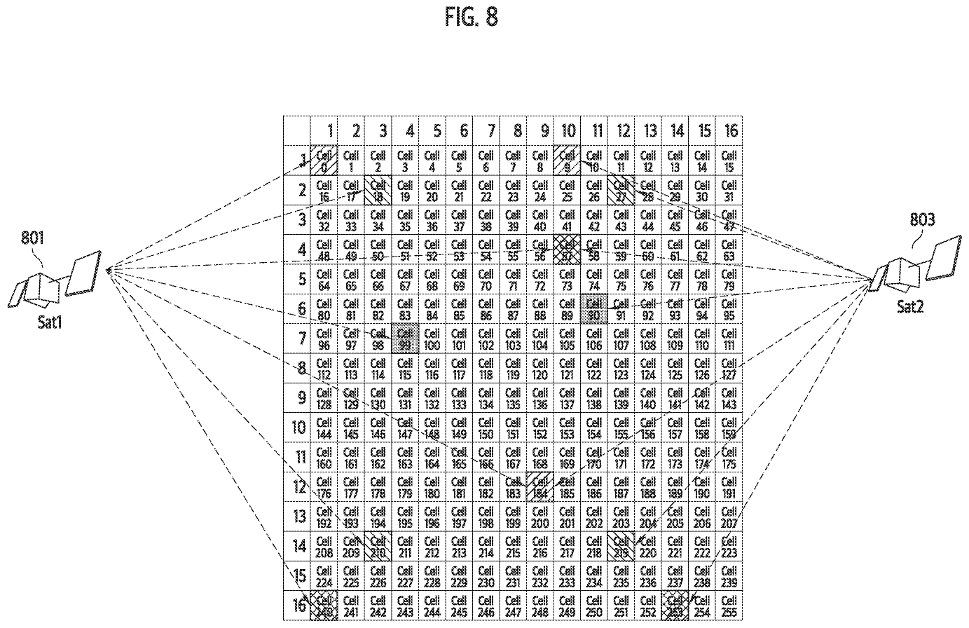

The electronic apparatus of FIG. 7 may correspond to an apparatus operated based on the above-described MPLS technique for the satellite in the space environment, and particularly, to an apparatus of a ground terminal performing transmission and reception of a signal through communication via a low-orbit satellite group. A cell arrangement operation of the low-orbit satellite group for implementing a network structure of the present disclosure including the electronic apparatus of FIG. 7 and a signal transmission method including packet processing may be performed as illustrated in an example of FIG. 8.

FIG. 8 is a diagram illustrating an example of a cell arrangement operation structure of a low-orbit communication satellite group.

The cell arrangement operation structure of FIG. 8 may correspond to a structure in which one satellite may support two hundred fifty-six cells. In FIG. 8, an assumption that a satellite system supports beam hopping may be a prerequisite for a large number of cells being supported by one satellite.

A beam hopping satellite system may be a system in which a satellite transmits a small number of beams with changing a steering point over a time to support a wide area in a timesharing manner. At this point, the wide area supported in the timesharing manner may be defined as a cluster. In a satellite group, multiple satellites may simultaneously support an identical location or cell depending on satellite orbit arrangement. In FIG. 8, two satellites supports one identical cluster. A satellite 1 of reference numeral 801 may support cells 0, 18, 57, 99, 184, 210, and 240, and a satellite 2 of reference numeral 803 may support cells 9, 27, 90, 219, and 253 as well as the cells 57 and 184. In this case, the satellite 1 of reference numeral 801 and the satellite 2 of reference numeral 803 are to simultaneously support the cells 57 and 184.

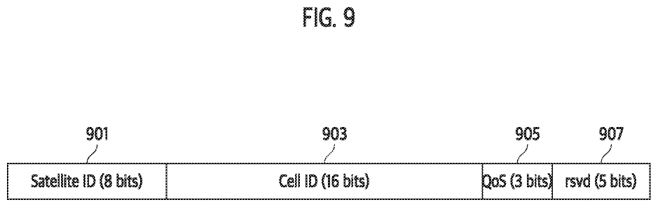

A label structure to be used by an electronic apparatus may be newly set as illustrated in FIG. 9 for performing communication based on the low-orbit communication satellite group which is operated according to a method with which a satellite supports cells in the cluster in a form as illustrated in FIG. 8.

FIG. 9 is a diagram illustrating a label structure for a low-orbit satellite group according to the present disclosure.

The label structure of FIG. 9 may include the following fields:
Satellite ID (Identifier) 901 (having 8 bits) for indicating two hundred fifty-six satellites of the low-orbit satellite group,
Cell ID 903 (having 16 bits) for indicating two hundred fifty-six clusters and two hundred fifty-six cells for each cluster,
Quality of service (QOS) 905 (having 3 bits) for indicating a class of a service, and
rsvd 907 (having 5 bits) that is a reserve.

In an example of the label structure of FIG. 9, a total number of satellites to be included in the low-orbit satellite group may be set to two hundred fifty-six, and a satellite ID may be allocated eight bits so as to indicate the two hundred fifty-six satellites. At this point, a number of bits allocated to the satellite ID may be set to be changed depending on an arrangement characteristic of the low-orbit satellite group. A cell ID may be allocated sixteen bits so as to indicate two hundred fifty-six clusters and two hundred fifty-six cells for each cluster to cover all surfaces of the earth. A number of bits for the cell ID may be also set to be changed depending on an orbit of the low-orbit satellite group and a cell arrangement characteristic. Further, three bits may be allocated to indicate QoS and communication quality. Similarly, a QoS indicator with the three bits may be also changed depending on a system characteristic. Additionally, an extra reserve bit may be included in the label structure of FIG. 9. When an additional instruction for a series of information is used, the reserve bit may be managed as a bit for the additional instruction.

A label set according to the structure of FIG. 9 may be not limited to have thirty-two bits and may be set differently depending on an altitude at which a satellite group used for communication in which a signal with the label attached is transmitted and received is operated. For example, the examples of FIGS. 8 and 9 which includes the two hundred fifty-six clusters and the two hundred fifty-six cells for each cluster may be an example of a situation in which the satellite group is operated at an altitude of approximately 1000 kilometers (km). Since a number of clusters and cells may be changed when the altitude at which the satellite group is operated is changed, a total number of bits in the label set according to the structure of FIG. 9 may be also set differently.

The label set according to the structure of FIG. 9 may be understood as identification information for identifying a destination IP address associated with another electronic apparatus to which an electronic apparatus is to transmit a signal. In other words, the label may be set to include a cell ID and a satellite ID corresponding to the destination IP address associated with the other electronic apparatus to which the electronic apparatus is to transmit the signal. When a signal with the label set as such attached is transmitted to a satellite, the cell ID and the satellite ID included in the label may be used for transmitting the signal to the destination IP address.

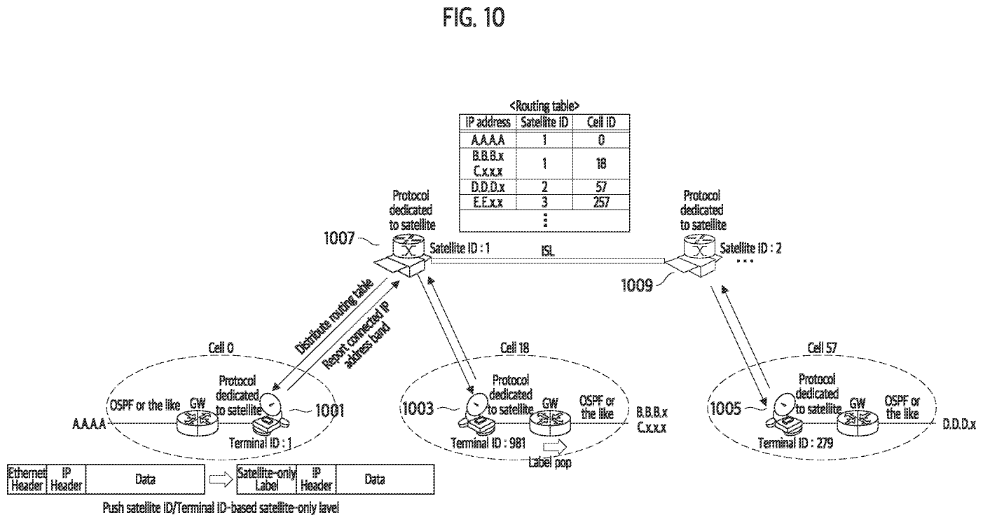

The electronic apparatus may transmit, to a predetermined satellite corresponding to the electronic apparatus, the signal which has a packet to which a label structure similar to that illustrated in FIG. 9 is attached. The predetermined satellite which receives the signal may identify, through the label structure of FIG. 9, information on a satellite and a cell corresponding to the other electronic apparatus to which the signal is to be transmitted and may transmit the signal to the satellite and the cell corresponding to the other electronic apparatus. A specific form of a configuration of a network based on the label structure for the low-orbit satellite group according to the present disclosure as illustrated in FIG. 9 may be similar to that illustrated in FIG. 10.

FIG. 10 is a diagram illustrating an example of a network structure based on a label structure for a low-orbit satellite group according to the present disclosure.

In FIG. 10, the electronic apparatus of FIG. 7 may correspond to a ground terminal of FIG. 10 and perform a role of attaching a label in a router provided to the ground terminal. At this point, the role of attaching the label may be understood as corresponding to a role of an LER in an MPLS system. The router of the ground terminal may also perform a role of a gateway that identifies a connected IP address band by being interlocked with a routing protocol (e.g., open shortest path first (OSPF)) used to maintain a routing table in commonly used routers which are built in a ground network and changes the connected IP address band into a satellite-only protocol. By the router of the ground terminal performing the role of attaching the label and the role of the gateway, a router provided to a satellite only needs to operate label-based switching and the satellite-only routing protocol. Accordingly, a burden of implementing hardware may be reduced.

A routing table may be configured as illustrated in an upper end portion of FIG. 10. The routing table may be information in a form of a predetermined table. The routing table may be set based on a parameter for identifying a satellite ID and a cell ID for each IP address included in a plurality of IP addresses used in communication through a satellite group and include information values for the satellite ID and the cell ID for the each IP address. In other words, the routing table information may include the each IP address which is used in communication through the satellite group and information on the satellite ID and the cell ID which correspond to the each IP address.

When an IP address band connected to a network is mapped to the satellite ID and the cell ID, and when the routing table is generated and maintained, routers in the network may share information on the routing table. The router of the ground terminal which corresponds to the electronic apparatus may attach a label corresponding to a corresponding destination IP address and transmit the label to a satellite network. The router provided to the satellite may read only the label and forward a packet to a port corresponding to the destination IP address. At this point, the label which is generated by the router of the ground terminal corresponding to the electronic apparatus may be understood, as described above, as identification information for identifying the destination IP address which is associated with another electronic apparatus to which the electronic apparatus is to transmit a signal. That is, the electronic apparatus to transmit the signal may generate the identification information so that the identification information includes the cell ID for identifying a cell corresponding to the destination IP address associated with the other electronic apparatus which is a target of signal transmission and the satellite ID for identifying a satellite for the cell corresponding to the destination IP address.

The router of the ground terminal may report an IP address band connected thereto to a satellite to which the ground terminal connects. Satellite routers may share information associated with the IP address band, generate a routing table in which information associated with various IP address bands is collected, and distribute the routing table to the ground terminal thereafter. In other words, the router of the ground terminal such as the electronic apparatus may report an IP address associated therewith to a satellite corresponding to a cell including the router, and according to such a method, a plurality of IP addresses for a plurality of ground terminals to perform communication through the satellite group may be collected. When the plurality of IP addresses is collected, routing table information including a satellite ID and a cell ID of each of the IP addresses may be generated in a portion of satellites included in the satellite group to correspond to the collected plurality of IP addresses. The generated routing table information may be shared with all the satellites included in the satellite group.

In the label, the satellite ID may be used to determine which satellite direction the packet may be forwarded to, and the cell ID may be used to determine which cell among cells assigned to one satellite the packet may be transmitted to. The cell ID may be used in a beam hopping satellite system (or a multi-beam satellite system) in which one satellite operates multiple cells.

In FIG. 10, for example, the electronic apparatus may correspond to a ground terminal 1001 having terminal ID 1. When the electronic apparatus attempts to transmit a signal to a ground terminal 1005 having terminal ID 279, in a state of acquiring and recognizing the information on the routing table, the electronic apparatus may identify “D.D.D.x” that is a destination IP address used by the ground terminal 1005 having terminal ID 279 and determine a satellite ID and a cell ID corresponding to “D.D.D.x” from the routing table. The electronic apparatus may generate a label that is identification information including the satellite ID and the cell ID corresponding to “D.D.D.x” to identify destination IP address “D.D.D.x” and may transmit a signal with the label attached to a data packet to a satellite. The electronic apparatus may identify that a satellite having satellite ID 1 corresponds to the satellite to which the electronic apparatus is to transmit the signal and may transmit the signal with the label attached to the data packet to a satellite 1007 that is the satellite having satellite ID 1. The satellite 1007 having satellite ID 1 may identify the label, determine the signal to be transmitted to a satellite having satellite ID 2 based on information on the satellite ID which is included in the label, and transmit the signal to a satellite 1009 that is the satellite having satellite ID 2. The satellite 1009 having satellite ID 2 may identify the label, determine the signal to be transmitted to a cell having cell ID 57 based on information on the cell ID which is included the label, and transmit the signal to the cell having cell ID 57. Through such a process, the signal may be transmitted to the ground terminal 1005 having terminal ID 279 which uses destination IP address “D.D.D.x”, and the data packet may be forwarded thereto.

Similarly, a signal transmission process for a ground terminal 1003 having terminal ID 981 using destination IP addresses “B.B.B.x” and “C.x.x.x” may be performed with a similar method.

According to the label structure and a network setting method which are proposed in the present disclosure and specialized for the low-orbit satellite group, in a satellite payload to which a high-performance processor may not be provided, high-speed packet switching in a Gbps speed may be easily implemented while a burden of configuring the hardware is reduced.

The present disclosure proposes the label structure which is based on the satellite ID and the cell ID. Through this, satellite-borne packet switching may be managed to be allowed even by simple hardware through processing of a label having a fixed length, not by an IP header processing method. In addition, the present disclosure proposes the network structure in which the ground terminal performs the role of attaching the label and the role of the gateway. Through this, a practical method of reducing the burden of implementing the hardware in a satellite payload in which applying a high-performance component is difficult when compared to a ground equipment may be provided. Further, even a cost of building a system for the low-orbit satellite group to operate hundreds or more of multiple satellites may be minimized.

Effects of the present disclosure are not limited to the above-mentioned effects and may be applied to correspond to scope not deviating from the technical idea and area of the present disclosure in various ways and in an extended manner.

Example embodiments of the present disclosure disclosed in the present specification and the figures are merely to propose a specific example so as to easily describe the technical content of the present disclosure and facilitate understanding of the present disclosure, and are not intended to limit the scope of the present disclosure. In other words, it will be apparent to those skilled in the art that other variation examples based on the technical idea of the present disclosure may be carried out. In addition, each of the example embodiments described above may be implemented in combination of each other as necessary. For example, parts of all example embodiments of the present disclosure may be combined with each other to be implemented by a system.

Also, a method in a system or the like according to the present disclosure may be implemented in a form of a program instruction that may be performed through various computer devices, and recorded on a computer-readable medium.

As such, various example embodiments of the present disclosure may be implemented as computer-readable code in a computer-readable recording medium from a specific point of view. The computer-readable recording medium may be a data storage device for storing data that may be read by a computer system. Examples of the computer-readable recording medium may include a read-only memory (ROM), a random-access memory (RAM), compact disk-read only memories (CD-ROMs), magnetic tapes, floppy disks, optical data storage devices, and carrier waves (e.g., data transmission through the Internet). Further, the computer-readable recording medium may be distributed through network-connected computer systems. Thus, the computer-readable code is stored and executed in a distributed manner. In addition, functional programs, code, and code segments for implementing various example embodiments of the present disclosure may be easily interpreted by skilled programmers in a field to which the present disclosure is applied.

Also, it may be understood that an apparatus and a method according to various example embodiments of the present disclosure may be realized in a form of hardware, software, or a combination of the hardware and the software. The software as such, for example, may be stored in a volatile or non-volatile storage device such as a ROM, a memory such as a RAM, a memory chip, a memory device, or an integrated circuit, or an optically or magnetically recordable and machine (e.g., a computer)-readable storage medium such as a compact disk (CD), a digital versatile disc (DVD), a magnetic disk, or a magnetic tape. It may be understood that the method according to various example embodiments of the present disclosure may be implemented by a computer including a controller and a memory, a vehicle including such a memory or computer. The memory as such may be one example of a machine-readable storage medium suitable for storing a program or programs including instructions for implementing example embodiments of the present disclosure.

Therefore, the present disclosure includes a program including code for implementing an apparatus or method described in the claims of the present disclosure and a machine (such as a computer)-readable storage medium that stores the program. In addition, the program as such may be electronically transmitted through any medium such as a communication signal delivered through a wired or wireless connection. The present disclosure includes equivalents thereof.

Various example embodiments of the present disclosure have been referenced and described above, but example embodiments of the present disclosure disclosed in the present specification and the figures are merely to propose a specific example so as to easily describe the technical content of the present disclosure and facilitate understanding of the present disclosure, and are not intended to limit the scope of the present disclosure. In addition, the above-described example embodiments of the present disclosure are merely examples, and it will be understood by those skilled in the art that other variations and example embodiments equivalent to the scope of the present disclosure may be carried out. Thus, the true technical scope of the present disclosure may be defined by the following claims.

It will be apparent to those skilled in the art that various modifications and variations can be made in the embodiments of the present disclosure without departing from the spirit or scope of the invention. Thus, it is intended that the present disclosure cover the modifications and variations of this disclosure provided they come within the scope of the appended claims and their equivalents.

What is claimed is:

1. A method of an electronic apparatus transmitting a signal, the method comprising:
acquiring routing table information including information associated with a plurality of Internet Protocol (IP) addresses;
generating, based on the routing table information, identification information for a predetermined IP address associated with another electronic apparatus to which a data packet is to be transmitted; and
transmitting a signal including the identification information and the data packet.

2. The method of claim 1, wherein the routing table information includes, as information in a form of a table:
each IP address included in the plurality of IP addresses; and
a satellite identifier (ID) and a cell ID corresponding to each respective IP address of the plurality of IP addresses.

3. The method of claim 1, wherein the routing table information is set to correspond to a satellite group including a first satellite for a first cell corresponding to the electronic apparatus, and
the routing table information is shared with a plurality of satellites included in the satellite group.

4. The method of claim 1, wherein the generating of the identification information comprises:
identifying information on the predetermined IP address;
identifying a cell ID of a second cell corresponding to the another electronic apparatus and the predetermined IP address and a satellite ID of a second satellite for the second cell based on the routing table information and the information on the predetermined IP address; and
generating the identification information which includes the cell ID and the satellite ID.

5. The method of claim 4, wherein the identification information is set based on a plurality of bits, and
the plurality of bits includes one or more bits for the satellite ID, one or more bits for the cell ID, one or more bits for indicating communication quality, and one or more reserve bits.

6. The method of claim 5, wherein a number of the plurality of bits is determined based on an altitude at which a satellite group including the second satellite and a first satellite for a first cell to which the electronic apparatus corresponds is operated.

7. The method of claim 1, wherein the transmitting of the signal comprises:
identifying a first satellite for a first cell to which the electronic apparatus corresponds; and
transmitting the signal to the first satellite.

8. The method of claim 7, wherein, based on a satellite ID included in the identification information, the signal is transmitted from the first satellite to a second satellite corresponding to the satellite ID, and
based on a cell ID included in the identification information, the signal is transmitted from the second satellite to a second cell corresponding to the cell ID.

9. A non-transitory computer-readable storage medium comprising a computer program for executing a signal transmission method,
wherein the signal transmission method comprises:
acquiring routing table information including information associated with a plurality of Internet Protocol (IP) addresses;
generating, based on the routing table information, identification information for a predetermined IP address associated with another electronic apparatus to which a data packet is to be transmitted; and
transmitting a signal including the identification information and the data packet.

10. An electronic apparatus for transmitting a signal, the electronic apparatus comprising:
a processor; and
one or more memories in which one or more instructions are stored,
wherein when executed, the one or more instructions control the processor to perform:
acquiring routing table information including information associated with a plurality of Internet Protocol (IP) addresses;
generating, based on the routing table information, identification information for a predetermined IP address associated with another electronic apparatus to which a data packet is to be transmitted; and
transmitting a signal including the identification information and the data packet.
